(19) United States
(12) Patent Application Publication
(10) Pub. No.: US 2012/0003391 A1
(43) Pub. Date: Jan. 5, 2012

(54) SEALING OFF A MELT DIP COATING APPARATUS

(75) Inventors: Peter De Kock, Oberhausen (DE); Ronald Norman Jabs, Rheinberg (DE)

(73) Assignee: SMS SIEMAG AKTIENGESELLSCHAFT, Düsseldorf (DE)

(21) Appl. No.: 13/257,096

(22) PCT Filed: Jul. 19, 2010
(86) PCT No.: PCT/EP2010/004384

§ 371 Date: Sep. 16, 2011

(30) Foreign Application Priority Data
Jul. 21, 2009 (DE) 10 2009 034 017.3

(51) Int. Cl. B05C 3/02; F16J 15/16; B05D 1/18

(52) U.S. Cl. 427/431; 118/426; 277/543

(57) ABSTRACT

The invention relates to a sealing system for a melt dip coating apparatus for coating a metal strip with a metal melt (200). The melt dip coating apparatus comprises a roller dipping into the metal melt for deflecting or stabilizing the metal strip as the latter passes through the metal melt (200), the roller having a roller body and a roller journal (224) and an airlock which surrounds the roller journal (224) with an airlock chamber (232), and a means for feeding the gaseous medium with a gas pressure into the airlock chamber (232) in order to seal off the airlock chamber (232) with respect to the metal melt (200). According to the invention, the sealing system in the region where the roller journal (224) passes into the airlock chamber (232) comprises a hollow cylindrical ring seal (225) to seal off the airlock chamber (232) with respect to the metal melt (200), wherein the hollow cylindrical ring seal (225) is designed to be divided parallel to or at an arbitrary angle to the axis of rotation of the roller journal (224) and, furthermore, the sealing system comprises a hollow cylindrical sleeve (226) which is slit in the direction of the axis of rotation of the roller journal (224) and which surrounds the ring seal (225).

### FIELD OF THE INVENTION

The invention concerns a hot dip coating installation for metal strip and a sealing system for such an installation as well as a method for operating a hot dip coating installation.

### PRIOR ART

A hot dip coating installation is described, for example, in DE 10 2004 030 207 A1. The installation disclosed there comprises a tank for the molten metal, through which the metal strip is passed. During its passage through the molten metal, the metal strip is deflected in the molten metal and stabilized by a roller, which has a roller body and a roller journal. The roller or the roller journal is supported by a roller bearing. To ensure proper functioning of the roller bearings, they must be protected from the aggressive molten metal. To this end, the shaft exit to the molten metal must be sealed by a seal to prevent molten metal from penetrating the roller bearing. In the document cited above, the seal is effected with a lock, which encloses the roller journal with a lock chamber, which—apart from lack of tightness at the shaft exit, i.e., at the transition to the shaft journal—is closed or sealed from the molten metal. To prevent penetration of the molten metal through the shaft exit, a gaseous medium is used to apply gas pressure to the lock chamber. The lock has a collecting tank for collecting leakage losses in the form of small amounts of molten metal that have been able to enter the lock chamber despite the gas pressure. This collecting tank must be emptied from time to time, for which purpose it must be dismounted and later remounted, which means that the operation of his lock is associated with increased maintenance costs.

Another previously known hot dip coating installation is disclosed by WO 2008/098687. FIGS. 1 and 2 of the present application show an example of this previously known installation. This prior-art installation, which is shown first in FIG. 1, comprises two vertical posts 102 arranged on either side of a tank 110 filled with a molten metal 200. A crosshead 103 is moved along the posts by vertical drives 104. Two support anus 105 are suspended from the crosshead 103, and a roller 120 is rotatably supported between the support arms 105. After the metal strip has been dipped into the molten metal, it is deflected upward again by the roller before leaving the molten metal.

FIG. 2 shows the tank 110 with the molten metal 200. The bath surface of the molten metal is identified by reference letter B. The roller 120 is suspended from the support arm 105 and is immersed in the molten metal 200 along with its bearing. The roller journal 124 is clearly visible. It is supported in a roller bearing 144 in the bearing chamber 142 of the support arm 105. Also shown are gas lines 170, 190 for supplying a gaseous medium, for example, nitrogen, to the bearing chamber 142. A lock 130 is arranged between the bearing chamber 142 and the roller body 122. It encloses the roller journal 124 with a lock chamber 132. Like the bearing housing 146 and the roller body 122, the lock 130 is immersed in the molten metal 200 and therefore is surrounded on the outside by the molten metal. The lock 130 and its lock chamber 132 are designed in the form of an immersion bell with a channel-like outlet 134, which is likewise immersed in the molten metal 200 during the operation of the hot dip coating installation. The outlet 134 is open to the molten metal. In the transition region between the bearing chamber 142 and the lock chamber 132, a dividing wall terminates on the journal side with a bushing 137, which surrounds the journal 124 of the roller 120. Between the inside diameter of the bushing 137 and the outside diameter of the journal 124, there is an annular gap 136 for controlled passage of the gaseous medium, e.g., N₂, between the bearing chamber 142 and the lock chamber 132.

In FIG. 2, the opposite wall 138 of the lock chamber 132, i.e., the wall facing the roll body 122, is flexibly designed, e.g., as a diaphragm. The wall 138 terminates on the journal side with an annular contact seal 139. However, this annular seal 139 is not 100% tight on the journal side, but rather a certain amount of untightness remains with respect to the journal 124. This untightness can be present both with respect to the gaseous medium, e.g., N₂, which can escape from the lock chamber 132 into the surrounding molten metal 200 via this leak, and with respect to the molten metal 200, which can enter the lock chamber 132 via the leak at the shaft exit 136.

The previously known sealing of the bearing 144 against penetrating molten metal 200 which is shown in FIG. 2 functions as follows: Nitrogen is conveyed into the bearing chamber 142 through the gas line 190. The nitrogen flows around the bearing 144 before flowing out into the lock chamber 132 through the annular gap 136′. The bearing chamber 142 and the lock chamber 132 are designed to communicate with each other with respect to the nitrogen via the annular gap 136. Therefore, equal gas pressure is established in both chambers. The gas pressure is chosen sufficiently high to prevent the molten metal 200 from penetrating to the inside of the lock chamber 132 through the open channel-like outlet 134 of the lock 130. At the same time, this pressure acts on the flexibly designed outer wall 138 of the lock chamber 132. This outer wall 138 is acted upon on the outside by the pressure exerted by the molten metal 200. Therefore, the annular contact seal 139 is pressed against the projection 123 or the roll body 122 by the differential pressure between the gas pressure inside the lock chamber 132 and the pressure exerted by the molten metal 200 on the outer wall 138 with a force K parallel to the axial direction R of the roller. For this purpose, the gas pressure inside the lock chamber 132 is dimensioned suitably great relative to the pressure exerted by the molten metal.

However, the penetration of some molten metal through the shaft exit 136 cannot be completely prevented in this way. It is still necessary to return penetrating molten metal to the metal bath in the tank 110 through an outlet 134 in the lock chamber 132.

Although the system described above can keep a portion of the molten metal from the bearing of the shaft journal, this cannot be totally achieved in practice, so that the bearing of the roller journal continues to sustain damage by penetrating molten metal. A further disadvantage of the previously known system illustrated in FIG. 2 is that the wall of the lock chamber must have a flexible design in the area of the journal exit, since otherwise the molten metal can penetrate into the lock 132 in large amounts through the opening 136. In particular, it is, unfortunately, not possible in the previously known embodiments of this system to reduce the fit tolerance at the shaft exit to any desired degree and thus achieve better tightness of the seal, since then the shaft would lock or jam due to thermal effects. Moreover, it would be desirable to have a lock with the simplest possible design, which, for example, no longer requires an outlet or a collecting tank. Another disadvantage of the system described above is that relatively large amounts of nitrogen are needed to prevent penetration by the molten metal. In this regard, large amounts of nitrogen are lost, which constitutes at least another cost factor. Optional systems for nitrogen recovery again lead to higher costs and considerable construction expense.

Other measures for sealing a lock chamber from molten metal, which are also described in the above-cited document WO 2008/098687, such as the provision of an inductive seal, are generally difficult to integrate due to the large space requirement and are technically very complicated. Another possibility that has been described for sealing a bearing by vertically contacting seals is difficult to control due to thermal expansions and fluctuating gas pressures.

Accordingly, the technical objective of the invention is to create a hot dip coating installation or a sealing system for such an installation, which overcomes at least one of the disadvantages specified above.

### DISCLOSURE OF THE INVENTION

The technical objective of the invention is achieved, first, by the sealing system of the invention for a hot dip coating installation for coating a metal strip with a molten metal, wherein the hot dip coating installation comprises a roller with a roller journal immersed in the molten metal and a lock that encloses the roller journal with a lock chamber, and the sealing system comprises an annular seal for sealing the lock chamber from the molten metal in the area of the passage of the roller journal into the lock chamber, wherein, in accordance with the invention, the hollow-cylindrical annular seal is designed in such a way that it is split parallel to the axis of rotation of the roller journal, and the sealing system comprises a hollow-cylindrical sleeve that is split in the direction of the axis of rotation of the roller journal, and the sleeve surrounds the hollow-cylindrical annular seal that is split parallel to the axis of rotation of the roller journal. This seal can effectively prevent the molten metal from penetrating the lock chamber, thereby increasing the service life of the roller bearing. The lock chamber can be constructed simply and inexpensively. In addition, gaseous medium is saved, because less gas, e.g., nitrogen, can escape into the melt through the smaller gap areas.

In a preferred embodiment of the installation, the hollow-cylindrical annular seal is split parallel to the axis of rotation of the roller journal into separate segments of a hollow cylinder.

In another preferred embodiment of the installation, the hollow-cylindrical annular seal is formed by at least four separate segments of a hollow cylinder.

In another preferred embodiment of the installation, the hollow-cylindrical annular seal has at least one flange element, which extends outward perpendicularly to the axis of rotation of the roller journal and with which the hollow-cylindrical annular seal abuts the wall of the lock chamber that is directed towards the molten metal.

In another preferred embodiment of the installation, the hollow-cylindrical sleeve has exactly one slit in the direction of the axis of rotation of the roller journal and/or is designed in such a way that it can exert a clamping effect on the segments of the hollow-cylindrical annular seal.

In another preferred embodiment of the installation, the separate segments of the hollow cylinder have essentially the form of segments of a circular arc in a cross section perpendicular to the axis of rotation of the roller journal.

In another preferred embodiment of the installation, each circular arc segment has essentially a circular arc partial circumference of 90°.

In another preferred embodiment of the installation, the annular seal is designed as an annular contact seal, which contacts the roller body or a projection of the roller journal.

The invention additionally comprises a hot dip coating installation for coating a metal strip with a molten metal, with a tank for the molten metal and a roller immersed in the molten metal for deflecting or stabilizing the metal strip during its passage through the molten metal, wherein the roller has a roller body and a roller journal as well as a lock, which encloses the roller journal with a lock chamber, and means for supplying a pressurized gaseous medium to the lock chamber to seal the lock chamber from the molten metal, wherein the hot dip coating installation includes the sealing system of the invention that was described above.

The invention further comprises a method for operating a hot dip coating installation with a roller, which has a roller body and a roller journal, and at least one lock, which encloses the roller journal with a lock chamber, which method has the following steps: passage of a metal strip through a molten metal, deflection or stabilization of the metal strip in the molten metal by means of the roller, and supplying a pressurized gaseous medium to the lock chamber to seal the lock chamber from the molten metal, wherein the lock chamber is sealed from the molten metal by a seal that is split parallel to the longitudinal axis of the roller journal. The advantages of the method of the invention and the hot dip coating installation of the invention result from and correspond essentially to those of the sealing system of the invention.

In a preferred embodiment of the method for operating a hot dip coating installation, the seal is pressed against the roller journal perpendicularly to the direction of the axis of rotation of the roller journal.

In another preferred embodiment of the method, the seal is pressed against the roller journal by an elastic force.

In another preferred embodiment of the method, the seal is pressed against the roller body or against a projection on the roller body by the gas pressure of the gaseous medium in the lock chamber with a force directed parallel to the axis of rotation of the roller journal.

### BRIEF DESCRIPTION OF THE FIGURES

FIGS. 1 and 2 show a prior-art installation for hot dip coating. FIG. 3 shows an embodiment of part of a hot dip coating installation in accordance with the invention. Further details of the invention are provided in the detailed description of the embodiments, which follows this brief description of the figures.

FIG. 1 shows a cross section of a prior-art arrangement of a hot dip coating installation.

FIG. 2 is a detail view of the cross section of FIG. 1, which shows especially the region of the passage of the roller journal into the lock chamber and into the roller bearing.

FIG. 3 is a schematic perspective view of an embodiment of a sealing system according to the invention or part of a hot dip melting installation according to the invention.

### DETAILED DESCRIPTION OF THE EMBODIMENTS

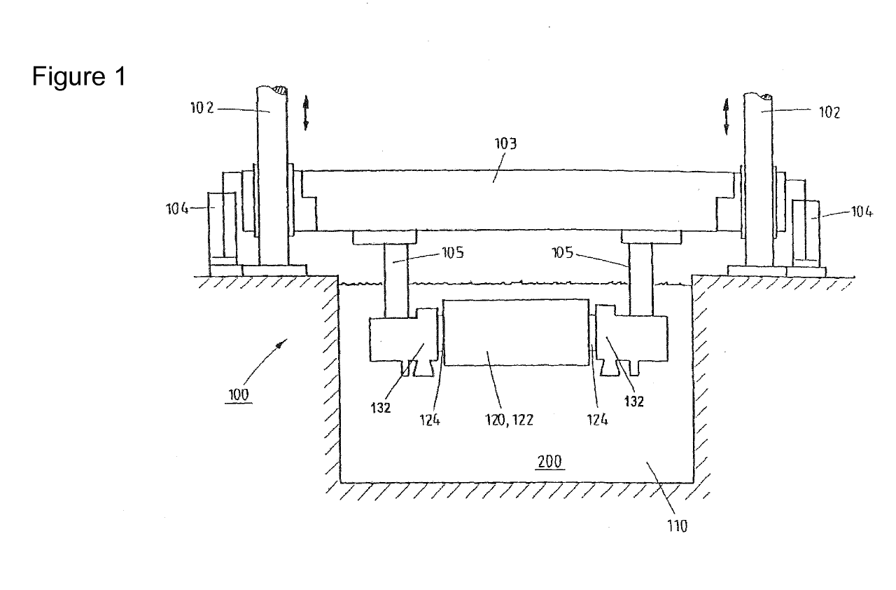

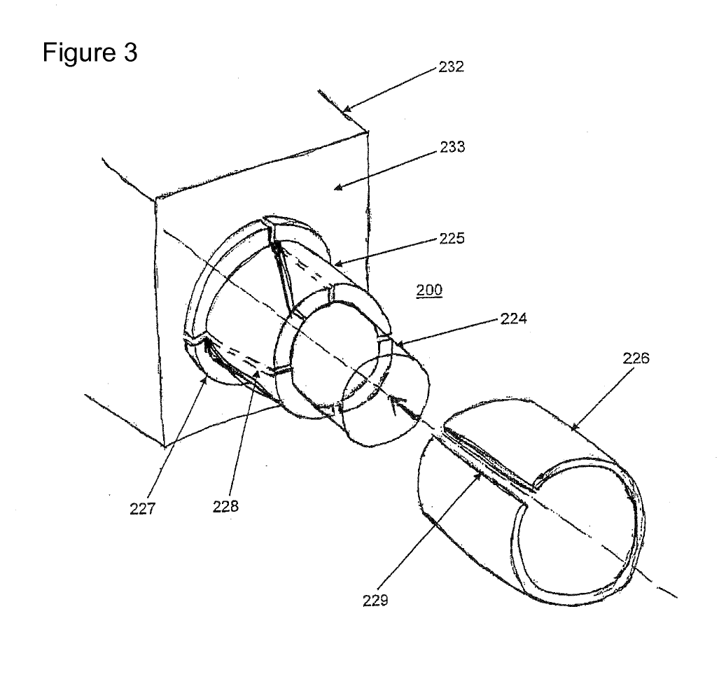

FIG. 3 is a schematic representation of an embodiment of a sealing system for a hot dip coating installation in accordance with the invention. The hot dip coating installation of the invention is not shown as a whole in FIG. 3. The general, basic design of such systems is known from the prior art (see FIG. 1, for example). The invention is aimed mainly at the object of the sealing of the passage of the roller journal 224 through the wall of a lock chamber 232. FIG. 3 is a schematic representation of such a lock chamber 232, through whose wall 233 the roller journal 224 passes. The lock chamber 232 is preferably flooded with nitrogen, as is known from the prior art. The nitrogen has a differential pressure relative to the metal bath 200 to prevent the molten metal 200 from entering the lock chamber 232. For the sake of clarity, the roller, the roller body, and the roller journal bearing are not shown in this drawing.

In accordance with the invention, an essentially hollow-cylindrical annular seal 225 or a hollow cylindrical ring 225 is provided to seal the passage of the roller journal 224 through the lock chamber wall 233. This annular seal 225 is split in the direction of the longitudinal axis or axis of rotation of the roller journal 224. This means that slits 228 or gaps 228 are provided in the annular seal 225 parallel to the axis of rotation of the roller journal 224. They preferably

extend the entire length of the annular seal 225 parallel to the axis of rotation of the roller journal 224 and are completely open in the radial direction. The annular seal 225 is thus divided into two separate parts or segments. Preferably, the annular seal 225 consists of four separate segments of a hollow cylinder, which is split parallel to the axis of rotation of the roller journal. However, it is also possible to provide only two or three such segments or to provide more than four segments. In a cross-sectional view perpendicular to the axis of rotation of the roller journal 224, each of these segments has the form of a section of a circular arc, and in the case of an annular seal 225 that consists of four segments, the circular arc sections or segments preferably have a circular arc partial circumference of essentially 90°. For a given number of segments of the hollow cylinder, the partial circumference of the circular arc of each individual segment t is preferably described by the formula t=360°/a, where a is the number of separate segments of the hollow cylinder.

A hollow-cylindrical sleeve 226 that is split parallel to the axis of rotation of the roller journal 224 is provided around the hollow-cylindrical annular seal 225. Preferably, there is exactly one slit that extends over the entire length of the sleeve and a completely open in the radial direction.

The annular seal 225 of the invention preferably has a flange 227 that abuts the wall 233 of the lock chamber 232, through which the roller journal extends. A flange 227 of this type can be realized in various ways. It can extend outward perpendicular to the surface of the cylindrical seal 225 and abut the wall of the lock chamber 233 either from the inside or from the side of the molten metal. It can also have a groove that fits into the wall 233. Experts are familiar with these kinds of flange designs. The flange 227 preferably abuts the inside of the wall 233 of the lock chamber 232 and is pressed against the wall 233 of the lock chamber 232 by the gas pressure inside the lock chamber 232.

The hollow-cylindrical annular seal 225 can expand when the roller journal 224 heats up without the journal 224 becoming stuck in the seal 225. Therefore, a tight fit of the annular seal 225 can be used. When the journal 224 heats up, the diameter of the journal 224 increases, which would lead to wear of the seal or jamming of the roller journal 224 if the annular seal were not split. By virtue of the split design of the seal 225 in accordance with the invention, the parts or segments of the seal 225 can move outward as the diameter of the roller journal 224 increases. If the annular seal 225 attains the inside diameter of the sleeve 226, the sleeve is spread open.

In this regard, the tightness of the lock chamber 232 is achieved especially by the hollow-cylindrical sleeve 226, whose elastic force presses together the hollow-cylindrical annular seal 225 perpendicularly to the direction of the axis of rotation of the roller journal 224. Moreover, the sealing system according to the invention has only comparatively small openings or gaps or slits 228 through which molten metal would be able to enter the chamber. In addition, the tightness in the area of the passage of the roller journal 224 through the wall 233 of the lock chamber 232 is preferably guaranteed by the gas pressure or nitrogen pressure that prevails inside the lock chamber 232. Preferably, the slit 229 in the sleeve 226 is arranged in such a way that it lies radially above the outer surface of the hollow-cylindrical annular seal 225, i.e., especially, that it is arranged above a segment of the split hollow-cylindrical annular seal 225 in such a way that the slit 229 of the sleeve 226 is not positioned above a gap or a slit 228 of the split hollow-cylindrical annular seal 225. In addition, it is possible, depending on the design, that the hollow-cylindrical annular seal 225 is pressed in the direction of the roller body and/or a possible projection on the roller journal 224 or on the roller body.

The sealing system of the invention is preferably used in a hot dip coating installation for coating metal strip with a molten metal 200, which comprises a tank for the molten metal 200 and a roller immersed in the molten metal for deflecting or stabilizing the metal strip during its passage through the molten metal, wherein the roller has a roller body and a roller journal 224. An installation of this type also has means for supplying a pressurized gaseous medium (e.g., N₂) to the lock chamber to seal the lock chamber 232 from the molten metal 200. However, it should be noted at this time that the sealing system of the invention can also be used in other types of hot dip coating installations.

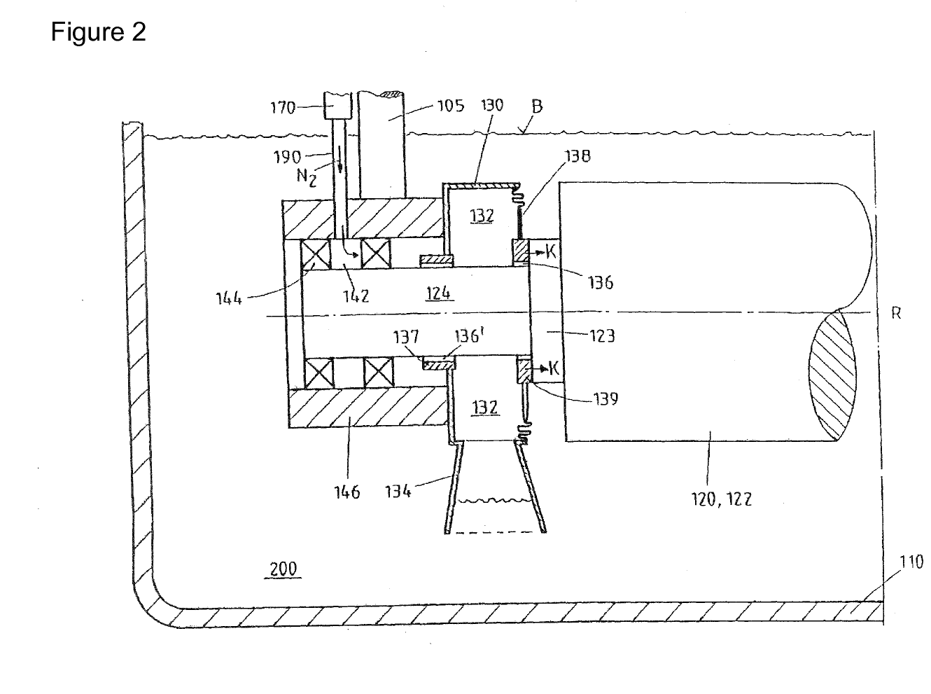

The sealing system described here can also be used in a known installation of the type illustrated in FIG. 2. This means, in particular, that the annular seal 139 shown in FIG. 2 is replaced by the annular seal 225 proposed by the invention together with the sleeve 226. The chamber wall 138 can then be designed either as a flexible wall or preferably as a rigid wall. Of course, the channel 136 shown in FIG. 2 is eliminated in the system of the invention. The channel-like outlet 134 can also be dispensed with in accordance with the invention. The sealing system of the invention allows better protection of the bearing of the roller journal from contaminants and effectively shields it from the molten metal 200.

It should be pointed out that the features described above can be combined with one another in any form. In addition, design details can be realized in modified forms on the basis of general knowledge by persons skilled in the art.

### LIST OF REFERENCE NUMBERS AND LETTERS

100 hot dip coating installation
102 post
103 crosshead
104 vertical drive
105 support arm
110 tank
120 roller
122 roller body
123 projection on the roller journal
124 roller journal
125 annular seal
126 sleeve
130 lock
132 lock chamber
134 channel-like outlet
136 shaft exit
136′ annular gap
137 bushing
138 outer wall
139 annular seal
142 bearing chamber
144 roller bearing
146 bearing housing
170 gas supply line
190 gas supply line
200 molten metal
224 roller journal
225 annular seal
226 sleeve
227 flange
228 gap
229 slit
232 lock chamber
233 lock chamber wall
B metal bath level
K force
R axial direction of the roller

1-13. (canceled)

14. A sealing system for a hot dip coating installation for coating a metal strip with a molten metal, wherein the hot dip coating installation includes a roller with a roller journal immersed in the molten metal and a lock that encloses the roller journal with a lock chamber, wherein the sealing system comprises: a hollow-cylindrical annular seal for sealing the lock chamber from the molten metal in an area of passage of the roller journal into the lock chamber, wherein the hollow-cylindrical annular seal is split at a desired angle to an axis of rotation of the roller journal and includes a hollow-cylindrical sleeve, which is split in a direction of the axis of rotation of the roller journal and surrounds the hollow-cylindrical annular seal that is split at a desired angle to the axis of rotation of the roller journal.

15. The sealing system according to claim 14, wherein the hollow-cylindrical annular seal is split parallel to the axis of rotation of the roller journal to form separate segments of a hollow cylinder.

16. The sealing system according to claim 15, wherein the hollow-cylindrical annular seal is formed by at least two separate segments of the hollow cylinder.

17. The sealing system according to claim 14, wherein the hollow-cylindrical annular seal has at least one flange element that extends outward perpendicularly to the axis of rotation of the roller journal and with which the hollow-cylindrical annular seal abuts a wall of the lock chamber that is directed towards the molten metal.

18. The sealing system according to claim 14, wherein the hollow-cylindrical sleeve has exactly one slit in the direction of the axis of rotation of the roller journal.

19. The sealing system according to claim 15, wherein the hollow-cylindrical sleeve is designed to exert a clamping effect on the segments of the hollow-cylindrical annular seal.

20. The sealing system according to claim 15, wherein the separate segments of the hollow cylinder are formed substantially as segments of a circular arc in a cross section perpendicular to the axis of rotation of the roller journal.

21. The sealing system according to claim 20, wherein each circular arc segment extends substantially over an angular range of 90° about the axis of rotation.

22. The sealing system according to claim 14, wherein the annular seal is an annular contact seal that contacts a body of the roller or a projection of the roller journal.

23. A hot dip coating installation for coating a metal strip with a molten metal, comprising: a tank for the molten metal; a roller immersed in the molten metal for deflecting or stabilizing the metal strip during passage through the molten metal, wherein the roller has a roller body and a roller journal as well as a lock that encloses the roller journal with a lock chamber; means for supplying a pressurized gaseous medium to the lock chamber to seal the lock chamber from the molten metal; and a sealing system having a hollow-cylindrical annular seal for sealing the lock chamber from the molten metal in an area of passage of the roller journal into the lock chamber, wherein the hollow-cylindrical annular seal is split at a desired angle to an axis of rotation of the roller journal and includes a hollow-cylindrical sleeve, which is split in a direction of the axis of rotation of the roller journal and surrounds the hollow-cylindrical annular seal that is split at a desired angle to the axis of rotation of the roller journal.

24. A method for operating a hot dip coating installation with a roller, which has a roller body and a roller journal, and at least one lock, which encloses the roller journal with a lock chamber, the method comprising the steps of: passing a metal strip through a molten metal; deflecting or stabilizing the metal strip in the molten metal by the roller; and supplying a pressurized gaseous medium to the lock chamber to seal the look chamber from the molten metal, wherein the lock chamber is sealed from the molten metal by a seal that is split parallel to a longitudinal axis of the roller journal.

25. The method for operating a hot dip coating installation according to claim 24, including pressing the seal against the roller journal perpendicularly to a direction of the axis of rotation of the roller journal.

26. The method for operating a hot dip coating installation according to claim 24, including pressing the seal against the roller journal by an elastic force.

27. The method for operating a hot dip coating installation according to claim 24, including pressing the seal against the roller body or against a projection on the roller body by gas pressure of the gaseous medium in the lock chamber with a force directed parallel to the axis of rotation of the roller journal.
